(19) United States
(12) Patent Application Publication
(10) Pub. No.: US 2025/0300707 A1
(43) Pub. Date: Sep. 25, 2025

(54) METHOD FOR DETERMINING AI BEAM MODEL, DEVICE, AND STORAGE MEDIUM

(71) Applicant: Beijing Xiaomi Mobile Software Co., Ltd., Beijing (CN)

(72) Inventor: Mingju LI, Beijing (CN)

(73) Assignee: Beijing Xiaomi Mobile Software Co., Ltd., Beijing (CN)

(21) Appl. No.: 18/860,309

(22) PCT Filed: Apr. 27, 2022
(86) PCT No.: PCT/CN2022/089676

§ 371 Date: Oct. 25, 2024

(51) Int. Cl. H04B 7/06; H04W 16/28

(52) U.S. Cl. CPC H04B 7/0617; H04W 16/28

(57) ABSTRACT

The present disclosure provides an AI beam model determination method, a device, and a storage medium. The method includes receiving an AI beam model sent by a network side device, and determining a first receive beam characteristic corresponding to the AI beam model.

### CROSS-REFERENCE TO RELATED APPLICATIONS

The present disclosure is a U.S. National phase application of International Application No. PCT/CN2022/089676, filed on Apr. 27, 2022, the entire content of which is incorporated herein by reference for all purposes.

### TECHNICAL FIELD

The present disclosure relates to the field of communication technology and, in particular, to a method and apparatus for determining an Artificial Intelligence (AI) beam model, a device, and a storage medium.

### BACKGROUND

In communication systems, beam-based transmission and reception are required to ensure the coverage of new radio technology (i.e., New Radio, NR) due to the fast fading of high frequency channels.

In the beam management process of the related technology, beam pairs can be measured by using a prediction method based on an Artificial Intelligence (AI) model.

### SUMMARY

In an aspect of the present disclosure, an embodiment proposes a method for determining an AI beam model, which is performed by a terminal and includes:
receiving an AI beam model sent by a network side device, and determining a first receive beam characteristic corresponding to the AI beam model.

In another aspect of the present disclosure, an embodiment proposes a method for determining an AI beam model, which is performed by a network side device and includes: sending an AI beam model to a terminal.

In yet another aspect of the present disclosure, an embodiment proposes a communication device including a processor and a memory, the memory having a computer program stored therein, the processor executing the computer program stored in the memory to cause the device to perform the method as set forth in the above aspect of embodiments.

In still another aspect of the present disclosure, an embodiment proposes a communication device including a processor and a memory, the memory having a computer program stored therein, the processor executing the computer program stored in the memory to cause the device to perform the method as set forth in another aspect of embodiments above.

In still another aspect of the present disclosure, an embodiment proposes a communication device including a processor and an interface circuit.

The interface circuit is configured to receive code instructions and transmit them to the processor.

The processor is configured to run the code instructions to perform the method as set forth in an aspect of embodiments.

In still another aspect of the present disclosure, an embodiment proposes a communication device including a processor and an interface circuit.

The interface circuit is configured to receive code instructions and transmit them to the processor.

The processor is configured to run the code instructions to perform the method as set forth in another aspect of embodiments.

In still another aspect of the present disclosure, an embodiment proposes a non-transitory computer-readable storage medium for storing instructions that, when the instructions are executed, cause the method as set forth in an aspect of embodiments to be implemented.

In still another aspect of the present disclosure, an embodiment proposes a non-transitory computer-readable storage medium for storing instructions that, when the instructions are executed, cause the method as set forth in another aspect of embodiments to be implemented.

### BRIEF DESCRIPTION OF THE DRAWINGS

The foregoing and/or additional aspects and advantages of the present disclosure will become apparent and readily understood from the following description of embodiments in conjunction with the accompanying drawings.

FIG. 1 is a flowchart of a method for determining an AI beam model provided by an embodiment of the present disclosure.

FIG. 2 is a flowchart of a method for determining an AI beam model provided by another embodiment of the present disclosure.

FIG. 3 is a flowchart of a method for determining an AI beam model provided by a further embodiment of the present disclosure.

FIG. 4 is a flowchart of a method for determining an AI beam model provided by yet another embodiment of the present disclosure.

FIG. 5 is a flowchart of a method for determining an AI beam model provided by yet another embodiment of the present disclosure.

FIG. 6 is a flowchart of a method for determining an AI beam model provided by yet another embodiment of the present disclosure.

FIG. 7 is a flowchart of a method for determining an AI beam model provided by yet another embodiment of the present disclosure.

FIG. 8 is a schematic diagram of a structure of an apparatus for determining an AI beam model provided by an embodiment of the present disclosure.

FIG. 9 is a schematic diagram of a structure of an apparatus for determining an AI beam model provided by another embodiment of the present disclosure.

FIG. 10 is a block diagram of a terminal provided by an embodiment of the present disclosure.

FIG. 11 is a block diagram of a network side device provided by an embodiment of the present disclosure.

### DETAILED DESCRIPTION

Exemplary embodiments will be described herein in detail, examples of which are represented in the accompanying drawings. When the following description relates to the accompanying drawings, the same numerals in the different accompanying drawings indicate the same or similar elements unless otherwise indicated. The implementation methods described in the following exemplary embodiments do not represent all implementation methods consistent with embodiments of the present disclosure. Rather, they are only examples of devices and methods consistent with some aspects of embodiments of the present disclosure as detailed in the appended claims.

Terms used in the embodiments of the present disclosure are used solely for the purpose of describing particular embodiments and are not intended to limit the embodiments of the present disclosure. The singular forms “a/an” and “the” as used in the embodiments of the present disclosure and in the appended claims are also intended to encompass the plural form, unless the context clearly indicates otherwise. It should also be understood that the term “and/or” as used herein refers to and encompasses any or all possible combinations of one or more of the associated listed items.

It should be understood that while the terms “first,” “second,” “third,” etc. may be employed in the embodiments of the present disclosure to describe various types of information, such information should not be limited by these terms. These terms are only used to distinguish the same type of information from one another. For example, without departing from the scope of embodiments of the present disclosure, first information may also be referred to as second information, and similarly, second information may be referred to as first information. Depending on the context, the word “if” or “in case of” as used herein may be interpreted as “at the time of . . . ” or “when . . . ” or “in response to determining . . . ”.

In the beam management process of the related technology, beam pairs can be measured by using a prediction method based on an Artificial Intelligence (AI) model. However, in the related technology, a terminal's failure to obtain the information of the AI model will result in inaccurate beam measurement quality by the AI model. Therefore, there is an urgent need for an “AI beam model determination” method to provide a receive beam characteristic corresponding to the AI beam model, and to improve the accuracy of obtaining a prediction result corresponding to the beam measurement quality of the AI beam model.

A method and apparatus for determining an AI beam model, a device, and a storage medium provided by embodiments of the present disclosure are described in detail below with reference to the accompanying drawings.

FIG. 1 is a flowchart of a method for determining an AI beam model provided by an embodiment of the present disclosure. This method is performed by a terminal, and as shown in FIG. 1, may include the following steps.

Step 101, receiving an AI beam model sent by a network side device and determining a first receive beam characteristic corresponding to the AI beam model.

It should be noted that in an embodiment of the present disclosure, the terminal may be a device that provides voice and/or data connectivity to a user. The terminal may communicate with one or more core networks via a Radio Access Network (RAN). The terminal may be an IoT terminal, such as a sensor device, a cell phone (or “cellular” phone), and a computer with an IoT terminal. For example, it may be a stationary, portable, pocket-sized, handheld, computer-built, or vehicle-mounted device. For example, it may be a station (STA), a subscriber unit, a subscriber station, a mobile station, a mobile, a remote station, an access point, a remote terminal, an access terminal, a user terminal, or a user agent. Alternatively, the terminal may be an unmanned aerial vehicle device. Alternatively, the terminal may be an in-vehicle device, for example, it may be a traveling computer with a wireless communication function, or a wireless terminal of an external traveling computer. Alternatively, the terminal may be a roadside device, e.g., it may be a street light, a signal light, or other roadside device, etc., having wireless communication functions.

In an embodiment of the present disclosure, before the terminal receives the AI beam model sent by the network side device, the method further includes:
sending an AI beam model request and/or a second receive beam characteristic to the network side device.

In an embodiment of the present disclosure, determining the first receive beam characteristic corresponding to the AI beam model includes:
receiving indication information sent by the network side device, where the indication information is configured to indicate the first receive beam characteristic corresponding to the AI beam model; or
determining the first receive beam characteristic corresponding to the AI beam model based on a default rule.

In an embodiment of the present disclosure, the first receive beam characteristic includes at least one of the following:
a first number of first receive beams supported by the AI beam model;
a number of first dimensional direction angles corresponding to the first receive beams in the AI beam model;
a first angular value of the first dimensional direction angle corresponding to the first receive beam in the AI beam model;
a number of second dimensional direction angles corresponding to the first receive beams in the AI beam model;
a second angular value of the second dimensional direction angle corresponding to the first receive beam in the AI beam model; or
a first beam identifier corresponding to the first receive beam in the AI beam model.

In an embodiment of the present disclosure, the second receive beam characteristic includes at least one of the following:
a second number of second receive beams supported by the terminal;
a number of first dimensional direction angles corresponding to the second receive beams in the terminal;
a first angular value of the first dimensional direction angle corresponding to the second receive beam in the terminal;
the number of second dimensional direction angles corresponding to the second receive beams in the terminal;
a second angular value of the second dimensional direction angle corresponding to the second receive beam in the terminal; or
a second beam identifier corresponding to the second receive beam in the terminal.

In an embodiment of the present disclosure, after receiving the AI beam model sent by the network side device, the method includes:
determining an AI beam model input parameter and inputting the input parameter into the AI beam model to obtain a prediction result of a beam measurement quality, where the input parameter includes at least one of the following:
a second receive beam characteristic;
a beam pair characteristic corresponding to a third number of beam pairs; or
a beam measurement quality corresponding to the third number of beam pairs.

In an embodiment of the present disclosure, the beam pair characteristic includes at least one of the following:
a beam pair identity (ID) corresponding to the beam pair;
a reference signal ID corresponding to the beam pair, where a reference signal includes at least one of: a synchronization signal block (SSB) or a channel state information reference signal (CSI-RS);
a second beam identifier corresponding to a second receive beam, the second receive beam corresponding to the beam pair;
a first angular value of a first dimensional direction angle of the second receive beam corresponding to the beam pair; or
a second angular value of a second dimensional direction angle of the second receive beam corresponding to the beam pair.

In an embodiment of the present disclosure, the beam measurement quality includes a layer one reference signal receiving power (L1-RSRP) and/or a layer one signal to interference plus noise ratio (L1-SINR).

Exemplarily, in an embodiment of the present disclosure, the first receive beam characteristic is the number of receive beams supported by the AI beam model, the second receive beam characteristic is the number of receive beams supported by the terminal, and the first receive beam characteristic includes the number of a plurality of receive beams.

Alternatively, the number of receive beams included in the first receive beam characteristic is less than or equal to the number of receive beams included in the second receive beam characteristic.

In summary, in embodiments of the present disclosure, the terminal may receive the AI beam model sent by the network side device, and determine the first receive beam characteristic corresponding to the AI beam model. In the embodiments of the present disclosure, by determining the first receive beam characteristic corresponding to the AI beam model through the terminal, the situation where the AI beam model does not correspond to the first receive beam characteristic is reduced, thereby improving the beam prediction accuracy of the AI beam model. The present disclosure provides a processing method for the case of “a method for determining an AI beam model” to provide the receive beam characteristic corresponding to the AI beam model, which improves the accuracy of obtaining a prediction result corresponding to a beam measurement quality of the AI beam model.

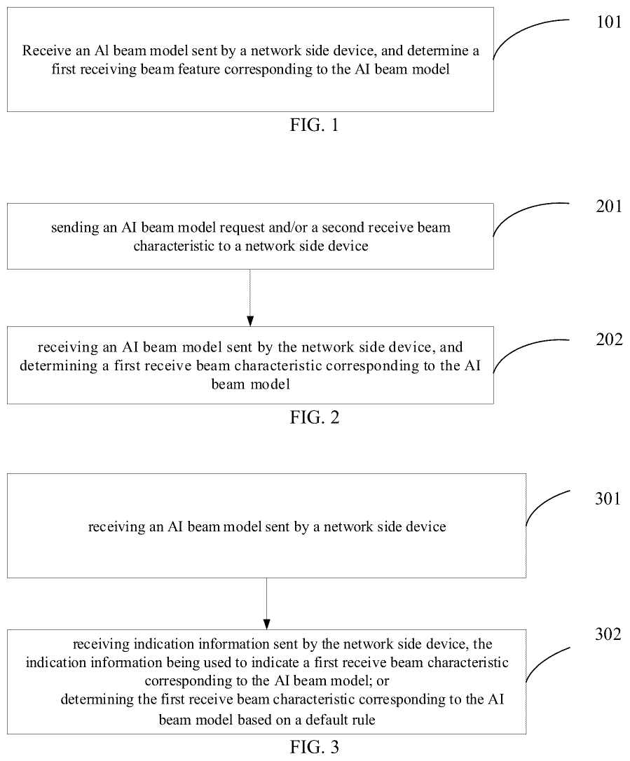

FIG. 2 is a flowchart of a method for determining an AI beam model provided by an embodiment of the present disclosure. This method is performed by a terminal, and as shown in FIG. 2, may include the following steps.

Step 201, sending an AI beam model request and/or a second receive beam characteristic to a network side device; Step 202, receiving an AI beam model sent by the network side device, and determining a first receive beam characteristic corresponding to the AI beam model.

In an embodiment of the present disclosure, the terminal sends the AI beam model request and/or the second receive beam characteristic to the network side device. Specifically, this can be implemented in the following manner: the terminal first sends the AI beam model request to the network side device, and then sends the second receive beam characteristic to the network side device; alternatively, the terminal first sends the second receive beam characteristic to the network side device, and then sends the AI beam model request to the network side device; or alternatively, the terminal simultaneously sends the second receive beam characteristic and the AI beam model request to the network side device. Specifically, when the terminal simultaneously sends the second receive beam characteristic and the AI beam model request to the network side device, the terminal may include the second receive beam characteristic in the AI beam model request, i.e., the terminal may send to the network side device the AI beam model request carrying the second receive beam characteristic.

In an embodiment of the present disclosure, the first receive beam characteristic includes at least one of the following:
a first number of first receive beams supported by the AI beam model;
a number of first dimensional direction angles corresponding to the first receive beams in the AI beam model;
a first angular value of the first dimensional direction angle corresponding to the first receive beam in the AI beam model;
a number of second dimensional direction angles corresponding to the first receive beams in the AI beam model;
a second angular value of the second dimensional direction angle corresponding to the first receive beam in the AI beam model; or
a first beam identifier corresponding to the first receive beam in the AI beam model.

In an embodiment of the present disclosure, the “first number” is used to refer only to the quantity of the first receive beams supported by the AI beam model. The first number does not refer specifically to a certain fixed number. The “first receive beams” or “first receive beam” refers to at least one first receive beam. For example, if an AI beam model supports at least one first receive beam with a first number of Q, it is indicated that this AI beam model is suitable for a terminal with the quantity of receive beam(s) of Q, where Q is a positive integer. Alternatively, if an AI beam model supports at least one first receive beam with a first number of Q, it is indicated that this AI beam model is suitable for a terminal with the quantity of receive beam(s) of less than or equal to Q, where Q is a positive integer. Alternatively, if an AI beam model supports at least one first receive beam, where the quantity of the at least one first receive beam is arbitrary, it is indicated that this AI beam model is suitable for a terminal with an arbitrary quantity of receive beam(s).

In an embodiment of the present disclosure, the “first receive beam characteristic” refers to the receive beam characteristic(s) supported by the AI beam model. The first receive beam characteristic does not specifically refer to a certain fixed receive beam characteristic. For example, when the number of features included in the first receive beam characteristic changes, the first receive beam characteristic may also change accordingly. For example, when a receive beam feature included in the first receive beam characteristic changes, the first receive beam characteristic may also change accordingly.

In an embodiment of the present disclosure, the “first dimensional direction angle” is only used to indicate any one of the direction angles in a plurality of dimensional directions, where the “first” of the first dimensional direction angle is only used to distinguish it from a second dimensional direction angle. This first dimensional direction angle does not specifically refer to a certain fixed direction angle.

Exemplarily, in an embodiment of the present disclosure, the “second dimensional direction angle” is only used to indicate any one of the direction angles in the plurality of dimensional directions that is different from the first dimensional direction angle, where the second dimensional direction angle does not specifically refer to a certain fixed direction angle. For example, when the first dimensional direction angle is a zenith angle, the second dimensional direction angle may be an azimuth angle. The first absolute value of the first dimensional direction angle ranges from 0 to 2*pi. The second absolute value of the second dimensional direction angle ranges from 0 to 2*pi.

In an embodiment of the present disclosure, the “first” of the “number of first dimensional direction angles” corresponding to the first receive beams is only used to distinguish it from the number of second dimensional direction angles corresponding to the first receive beams. The number of first dimensional direction angles corresponding to the first receive beams does not specifically refer to a certain fixed number. The number of second dimensional direction angles corresponding to the first receive beams does not specifically refer to a certain fixed number. The “first receive beams” or “first receive beam” refers to at least one first receive beam.

In an embodiment of the present disclosure, for example, if an AI beam model supports at least one first receive beam having the number of first dimensional direction angle(s) of N, it is indicated that this AI beam model is suitable for a terminal where the number of first dimensional direction angle(s) of the receive beam(s) is N, N being a positive integer. Alternatively, if an AI beam model supports at least one first receive beam having the number of first dimensional direction angle(s) of N, it is indicated that this AI beam model is suitable for a terminal where the number of first dimensional direction angle(s) of the receive beam(s) is less than or equal to N, N being a positive integer. Alternatively, if an AI beam model supports at least one first receive beam having any number of first dimensional direction angle(s), it is indicated that this AI beam model is suitable for a terminal where the number of first dimensional direction angle(s) of the receive beam(s) is arbitrary.

Exemplarily, in an embodiment of the present disclosure, for example, if an AI beam model supports at least one first receive beam having the number of second dimensional direction angle(s) of M, it is indicated that this AI beam model is suitable for a terminal where the number of second dimensional direction angle(s) of the receive beam(s) is M, M being a positive integer. Alternatively, if an AI beam model supports at least one first receive beam having the number of second dimensional direction angle(s) of M, it is indicated that this AI beam model is suitable for a terminal where the number of second dimensional direction angle(s) of the receive beam(s) is less than or equal to M, M being a positive integer. Alternatively, if an AI beam model supports at least one first receive beam having any number of second dimensional direction angle(s), it is indicated that this AI beam model is suitable for a terminal where the number of second dimensional direction angle(s) of the receive beam(s) is arbitrary. It should be noted that in this case, the number of first receive beam(s) supported by the AI beam model is the product of M and N.

Exemplarily, the “first angular value” of the first dimensional direction angle corresponding to the first receive beam is an angular value of the first dimensional direction angle corresponding to the first receive beam. The “second angular value” of the first dimensional direction angle corresponding to the first receive beam is an angular value of the second dimensional direction angle corresponding to the first receive beam. The “first” of the “first angular value” of the first dimensional direction angle corresponding to the first receive beam is only used to distinguish it from the second angular value of the first dimensional direction angle corresponding to the first receive beam. The first angular value of the first dimensional direction angle corresponding to the first receive beam does not specifically refer to a certain fixed value. The “first receive beams” or “first receive beam” refers to at least one first receive beam.

In an embodiment of the present disclosure, for example, if an AI beam model supports at least one first receive beam, whose first dimensional direction angles have first angular values of θ₁, θ₂, . . . , θ_{N}, it is indicated that this AI beam model is suitable for a terminal where the number of first dimensional direction angles of the receive beams is N and the first angular values of the first dimensional direction angles are θ₁, θ₂, . . . , θ_{N}, where each 0, ranges from 0 to 2*pi, N being a positive integer. Alternatively, if an AI beam model supports at least one first receive beam, whose first angular values of the first dimensional direction angles are arbitrary, it is indicated that this AI beam model is suitable for a terminal where the first angular values of the first dimensional direction angles of the receive beams are arbitrary.

For another example, if an AI beam model supports at least one first receive beam, whose second dimensional direction angles have second angular values of θ₁, θ₂, . . . , θ_{M}, it is indicated that this AI beam model is suitable for a terminal where the number of second dimensional direction angles of the receive beams is M and the second angular values of the second dimensional direction angles are θ₁, θ₂, . . . , θ_{M}, where each 0, ranges from 0 to 2*pi, M being a positive integer. Alternatively, if an AI beam model supports at least one first receive beam, whose second angular values of the second dimensional direction angles are arbitrary, it is indicated that this AI beam model is suitable for a terminal where the second angular values of the second dimensional direction angles of the receive beams are arbitrary.

Further, in an embodiment of the present disclosure, a receive beam identifier is used to uniquely identify a receive beam. That is, different receive beams correspond to different receive beam identifiers. The “first receive beams” or “first receive beam” refers to at least one first receive beam. The first beam identifier(s) is/are used to indicate an identifier or identifiers of the at least one first receive beam. For example, if the first receive beam characteristic includes that the first beam identifiers corresponding to the first receive beams in the AI beam model are a first beam identifier ID #1 and a first beam identifier ID #2, it is indicated that this AI beam model is suitable for a terminal where the first beam identifiers of the receive beams are the first beam identifier ID #1 and the first beam identifier ID #2, or it is also used to indicate that the input for the beam prediction carried out using the AI beam model includes a measurement quality of at least one first beam pair, and that the receive beam identifiers corresponding to the at least one first beam pair are the first beam identifier ID #1 and the first beam identifier ID #2.

In an embodiment of the present disclosure, the second receive beam characteristic includes at least one of:
a second number of second receive beams supported by the terminal;
a number of first dimensional direction angles corresponding to the second receive beams in the terminal;
a first angular value of the first dimensional direction angle corresponding to the second receive beam in the terminal;
a number of second dimensional direction angles corresponding to the second receive beams in the terminal;
a second angular value of the second dimensional direction angle corresponding to the second receive beam in the terminal; or
a second beam identifier corresponding to the second receive beam in the terminal.

In an embodiment of the present disclosure, the “second receive beam characteristic” refers to the receive beam characteristic(s) supported by the terminal. The second receive beam characteristic does not specifically refer to a certain fixed receive beam characteristic. For example, when the number of features included in the second receive beam characteristic changes, the second receive beam characteristic may also change accordingly. For example, when a receive beam feature included in the second receive beam characteristic changes, the second receive beam characteristic may also change accordingly.

In an embodiment of the present disclosure, the “first” of the “number of first dimensional direction angles” corresponding to the second receive beams is only used to distinguish it from the number of second dimensional direction angles corresponding to the second receive beams. The number of first dimensional direction angles corresponding to the second receive beams does not specifically refer to a certain fixed number. The number of second dimensional direction angles corresponding to the second receive beams does not specifically refer to a certain fixed number. The “second receive beam” or “second receive beams” refers to at least one second receive beam. For example, the terminal supports the second receive beam(s) whose number of first dimensional direction angle(s) is A, and whose number of second dimensional direction angle(s) is B, where A and B are both positive integers. It should be noted that in this case, the number of second receive beam(s) supported by the terminal is the product of A and B.

Exemplarily, the “first angular value” of the first dimensional direction angle corresponding to the second receive beam is an angular value of the first dimensional direction angle corresponding to the second receive beam. The “second angular value” of the second dimensional direction angle corresponding to the second receive beam is an angular value of the second dimensional direction angle corresponding to the second receive beam. The “first” of the “first angular value” of the first dimensional direction angle corresponding to the second receive beam is only used to distinguish it from the second angular value of the second dimensional direction angle corresponding to the second receive beam. The first angular value of the first dimensional direction angle corresponding to the second receive beam does not specifically refer to a certain fixed angular value. The “second receive beam” or “second receive beams” refers to at least one second receive beam.

For example, if a terminal supports the second receive beams, whose first dimensional direction angles have the first angular values of θ1, θ2, . . . , θA, it is indicated that the number of first dimensional direction angles of the second receive beams supported by the terminal is A, and that the first angular values of the first dimensional direction angles are θ1, θ2, . . . , θA, where each θi ranges from 0 to 2*pi, A being a positive integer.

For another example, if a terminal supports the second receive beams, whose second dimensional direction angles have the second angular values of θ₁, θ₂, . . . , θ_{B}, it is indicated that the number of second dimensional direction angles of the second receive beams supported by the terminal is B, and that the second angular values of the second dimensional direction angles are θ₁, θ₂, . . . , θ_{B}, where each 0, ranges from 0 to 2*pi, B being a positive integer.

In an embodiment of the present disclosure, the “second number” is used to refer only to the quantity of the second receive beam(s) supported by the terminal. The second number does not specifically refer to a certain fixed number. The “second receive beam” or “second receive beams” refers to at least one second receive beam. For example, if the number of receive beam(s) supported by the terminal is W, the second number is W, W being a positive integer. The number of receive beams is represented as “Rxbeamnumber”.

Further, in an embodiment of the present disclosure, a receive beam identifier is used to uniquely identify a receive beam. That is, different receive beams correspond to different receive beam identifiers. The “second receive beam” or “second receive beams” refers to at least one second receive beam. The second receive beam identifier(s) is/are used to indicate an identifier or identifiers of the at least one second receive beam. For example, if the terminal includes two receive beams with identifiers ID #1 and ID #2, respectively, the second receive beam identifiers are a second beam identifier ID #1 and a second beam identifier ID #2.

Further, in an embodiment of the present disclosure, the terminal may receive beam configuration information from the network side device, the beam configuration information being used to indicate a transmission configuration indication (TCI) state.

In an embodiment of the present disclosure, the TCI state includes at least one Quasi Co-Location (QCL) type.

In addition, in an embodiment of the present disclosure, the QCL types include QCL Type A, QCL Type B, QCL Type C, and QCL Type D. QCL Type D is used to indicate the reception parameter information. QCL Type A includes at least one of parameters related to a Doppler shift parameter, a Doppler spread parameter, an average delay parameter, and a delay spread parameter. QCL Type B includes at least one of parameters related to a Doppler shift parameter, a Doppler spread parameter, an average delay parameter, and a delay spread parameter. QCL Type C includes at least one of parameters related to a Doppler shift parameter, a Doppler spread parameter, an average delay parameter, and a delay spread parameter.

In summary, in embodiments of the present disclosure, the terminal may receive the AI beam model sent by the network side device and determine the first receive beam characteristic corresponding to the AI beam model. In the embodiments of the present disclosure, the terminal can determine the first receive beam characteristic corresponding to the AI beam model after sending the AI beam model request and/or the second receive beam characteristic to the network side device, thereby improving the matching degree between the second receive beam characteristic and the AI beam model, and improving the beam prediction accuracy of the AI beam model. The present disclosure provides a processing method for the case of “a method for determining an AI beam model” to provide the receive beam characteristic corresponding to the AI beam model, which improves the accuracy of obtaining a prediction result corresponding to a beam measurement quality of the AI beam model.

FIG. 3 is a flowchart of a method for determining an AI beam model provided by an embodiment of the present disclosure. This method is performed by a terminal, and as shown in FIG. 3, may include the following steps.

Step 301, receiving an AI beam model sent by a network side device.

Step 302, receiving indication information sent by the network side device, the indication information being used to indicate a first receive beam characteristic corresponding to the AI beam model.

Alternatively, step 302, determining the first receive beam characteristic corresponding to the AI beam model based on a default rule.

In an embodiment of the present disclosure, in the case where the terminal determines the first receive beam characteristic corresponding to the AI beam model, the terminal may receive the indication information sent by the network side device. Since the indication information is used to indicate the first receive beam characteristic corresponding to the AI beam model, the terminal can obtain the first receive beam characteristic corresponding to the AI beam model based on the indication information.

In addition, in an embodiment of the present disclosure, the terminal may determine the first receive beam characteristic corresponding to the AI beam model based on the default rule.

In an embodiment of the present disclosure, where the first receive beam characteristic is, for example, the number of receive beams, the default rule may specifically be an indication that the AI beam model is suitable for a terminal where the number of the receive beams is arbitrary.

In an embodiment of the present disclosure, the first receive beam characteristic includes at least one of the following:
a first number of first receive beams supported by the AI beam model;
a number of first dimensional direction angles corresponding to the first receive beams in the AI beam model;
a first angular value of the first dimensional direction angle corresponding to the first receive beam in the AI beam model;
a number of second dimensional direction angles corresponding to the first receive beams in the AI beam model;
a second angular value of the second dimensional direction angle corresponding to the first receive beam in the AI beam model; or
a first beam identifier corresponding to the first receive beam in the AI beam model.

In summary, in embodiments of the present disclosure, the terminal may receive the AI beam model sent by the network side device, and determine the first receive beam characteristic corresponding to the AI beam model. In the embodiments of the present disclosure, the terminal device obtains the first receive beam characteristic corresponding to the AI beam model by receiving the indication information sent by the network side device, or determines the first receive beam characteristic corresponding to the AI beam model based on the default rule, so as to improve the accuracy of the determination of the first receive beam characteristic and improve the beam prediction accuracy of the AI beam model. The present disclosure provides a processing method for the case of “a method for determining an AI beam model” to provide the receive beam characteristic corresponding to the AI beam model, which improves the accuracy of obtaining a prediction result corresponding to a beam measurement quality of the AI beam model.

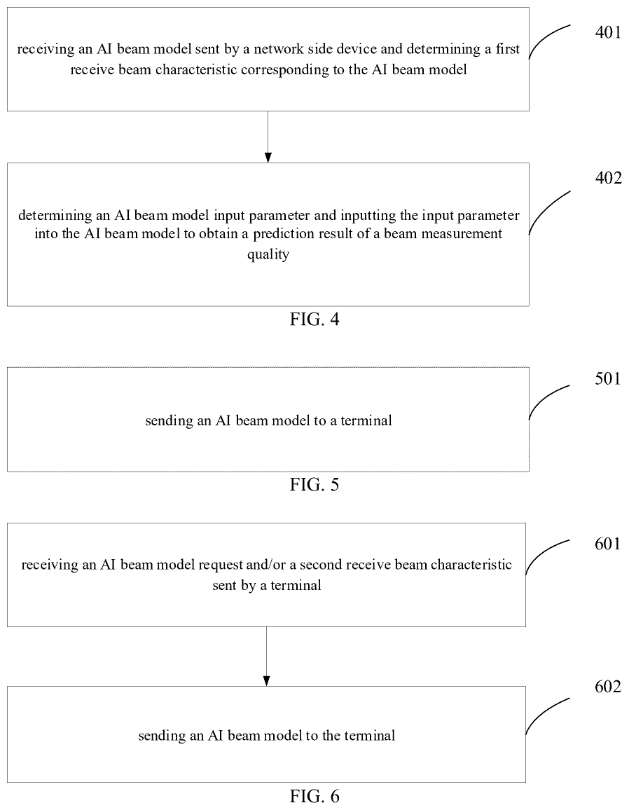

FIG. 4 is a flowchart of a method for determining an AI beam model provided by an embodiment of the present disclosure. This method is performed by a terminal, and as shown in FIG. 4, may include the following steps.

Step 401, receiving an AI beam model sent by a network side device and determining a first receive beam characteristic corresponding to the AI beam model.

Step 402, determining an AI beam model input parameter and inputting the input parameter into the AI beam model to obtain a prediction result of a beam measurement quality.

In an embodiment of the present disclosure, the input parameter is one that can be associated with an AI beam model. The AI beam model may correspond only to a specific receive beam characteristic, or it may correspond to a plurality of receive beam characteristics. For example, the AI beam model may be one that corresponds only to the number of receive beams, in which case the input parameter corresponding to the AI beam model would be the number of receive beams. Alternatively, the AI model may correspond to all of the receive beam characteristics.

Exemplarily, in an embodiment of the present disclosure, the input parameter includes at least one of the following:
a second receive beam characteristic;
a beam pair characteristic corresponding to a third number of beam pairs; or
a beam measurement quality corresponding to the third number of beam pairs.

In an embodiment of the present disclosure, the “third number” refers to the quantity of beam pair(s). The third number does not specifically refer to a certain fixed number. The third number is the quantity of beam pair(s) to be measured by the terminal. For example, the third number of beam pair(s) to be measured by the terminal is M*N, where M represents the number of transmit beam(s) of the network side device, with each transmit beam corresponding to a reference signal ID, and N represents the number of receive beam(s) of the terminal. M and N are both positive integers.

In an embodiment of the present disclosure, the input parameter may include, for example, a second receive beam characteristic, a beam pair characteristic corresponding to a third number of beam pair(s), and a beam measurement quality corresponding to the third number of beam pair(s). The terminal may input the second receive beam characteristic, the beam pair characteristic corresponding to the third number of beam pair(s), and the beam measurement quality corresponding to the third number of beam pair(s) into the AI beam model to obtain a prediction result of a beam measurement quality.

In an embodiment of the present disclosure, the beam pair characteristic includes at least one of the following:
a beam pair ID corresponding to the beam pair;
a reference signal ID corresponding to the beam pair, where a reference signal includes at least one of: a synchronization signal block (SSB) or a channel state information reference signal (CSI-RS);
a second beam identifier corresponding to a second receive beam, the second receive beam corresponding to the beam pair;
a first angular value of a first dimensional direction angle of the second receive beam corresponding to the beam pair; or
a second angular value of a second dimensional direction angle of the second receive beam corresponding to the beam pair.

In an embodiment of the present disclosure, the “first angular value” is only used to indicate an angular value of a first dimensional direction angle of a second receive beam that corresponds to a beam pair. The “second angular value” is only used to indicate an angular value of a second dimensional direction angle of a second receive beam that corresponds to a beam pair. The “first” in the “first angular value” is only used to distinguish it from the second angular value, and the first angular value does not specifically refer to a certain fixed angular value.

In an embodiment of the present disclosure, the “first dimensional direction angle” is only used to indicate any one of the direction angles in a plurality of dimensional directions, where the “first” of the “first dimensional direction angle” is only used to distinguish it from the second dimensional direction angle. This first dimensional direction angle does not specifically refer to a certain fixed direction angle.

Further, the “second dimensional direction angle” is only used to indicate any one of the direction angles in the plurality of dimensional directions that is different from the first dimensional direction angle. This second dimensional direction angle does not specifically refer to a certain fixed direction angle. For example, when the first dimensional direction angle is a zenith angle, the second dimensional direction angle may be an azimuth angle.

Exemplarily, in an embodiment of the present disclosure, the beam measurement quality includes a layer one reference signal receiving power (L1-RSRP) and/or a layer one signal to interference plus noise ratio (L1-SINR).

Further, in an embodiment of the present disclosure, the first receive beam characteristic is the number of receive beam(s) supported by the AI beam model, the second receive beam characteristic is the number of receive beam(s) supported by the terminal, and the first receive beam characteristic includes the number of a plurality of receive beams.

Alternatively, the number of receive beam(s) included in the first receive beam characteristic is less than or equal to the number of receive beam(s) included in the second receive beam characteristic.

In an embodiment of the present disclosure, “the number of receive beam(s) included in the first receive beam characteristic is less than or equal to the number of receive beam(s) included in the second receive beam characteristic” is used to indicate that the number of receive beam(s) supported by the AI model is less than or equal to the number of receive beam(s) supported by the terminal.

In summary, in embodiments of the present disclosure, the terminal may receive the AI beam model sent by the network side device, and determine the first receive beam characteristic corresponding to the AI beam model. In the embodiments of the present disclosure, the terminal obtains a prediction result of the beam measurement quality by determining the input parameter of the AI beam model and inputting the input parameter into the AI beam model, so as to improve the matching performance between the input parameters and the AI model, and improve the accuracy of obtaining a prediction result corresponding to the AI beam model. The present disclosure provides a processing method for the case of “a method for determining an AI beam model” to provide the receive beam characteristic corresponding to the AI beam model, which improves the accuracy of obtaining a prediction result corresponding to a beam measurement quality of the AI beam model.

FIG. 5 is a flowchart of a method for determining an AI beam model provided by an embodiment of the present disclosure. This method is performed by a network side device, and as shown in FIG. 5, may include the following steps.

Step 501, sending an AI beam model to a terminal.

In an embodiment of the present disclosure, before sending the AI beam model to the terminal, the method further includes:
receiving an AI beam model request and/or a second receive beam characteristic sent by the terminal.

In an embodiment of the present disclosure, the second receive beam characteristic includes at least one of the following:
a second number of second receive beams supported by the terminal;
a number of first dimensional direction angles corresponding to the second receive beams in the terminal;
a first angular value of the first dimensional direction angle corresponding to the second receive beam in the terminal;
a number of second dimensional direction angles corresponding to the second receive beams in the terminal;
a second angular value of the second dimensional direction angle corresponding to the second receive beam in the terminal; or
a second beam identifier corresponding to the second receive beam in the terminal.

Exemplarily, in an embodiment of the present disclosure, sending the AI beam model to the terminal includes:
sending indication information to the terminal, where the indication information is used to indicate a first receive beam characteristic corresponding to the AI beam model.

Further, in an embodiment of the present disclosure, the first receive beam characteristic includes at least one of the following:
a first number of first receive beams supported by the AI beam model;
a number of first dimensional direction angles corresponding to the first receive beams in the AI beam model;
a first angular value of the first dimensional direction angle corresponding to the first receive beam in the AI beam model;
a number of second dimensional direction angles corresponding to the first receive beams in the AI beam model;
a second angular value of the second dimensional direction angle corresponding to the first receive beam in the AI beam model; or
a first beam identifier corresponding to the first receive beam in the AI beam model.

In an embodiment of the present disclosure, the first receive beam characteristic is the number of receive beam(s) supported by the AI beam model, the second receive beam characteristic is the number of receive beam(s) supported by the terminal, and the first receive beam characteristic includes the number of a plurality of receive beams.

Alternatively, the number of receive beam(s) included in the first receive beam characteristic is less than or equal to the number of receive beam(s) included in the second receive beam characteristic.

In summary, in embodiments of the present disclosure, the network side device may send the AI beam model to the terminal. In the embodiments of the present disclosure, the matching performance, between the input parameter determined by the terminal and the AI model, can be improved by the network side device indicating the first receive beam characteristic corresponding to the AI beam model. The present disclosure provides a processing method for the case of “a method for determining an AI beam model” to provide the receive beam characteristic corresponding to the AI beam model, which improves the accuracy of obtaining a prediction result corresponding to a beam measurement quality of the AI beam model.

FIG. 6 is a flowchart of a method for determining an AI beam model provided by an embodiment of the present disclosure. This method is performed by a network side device, and as shown in FIG. 6, may include the following steps.

Step 601, receiving an AI beam model request and/or a second receive beam characteristic sent by a terminal.

Step 602, sending an AI beam model to the terminal.

In an embodiment of the present disclosure, the network side device receives the AI beam model request and/or the second receive beam characteristic sent by the terminal, so that the network side device can determine an AI beam model corresponding to the second receive beam characteristic and send the AI beam model to the terminal.

In an embodiment of the present disclosure, the second receive beam characteristic includes at least one of the following:
a second number of second receive beams supported by the terminal;
a number of first dimensional direction angles corresponding to the second receive beams in the terminal;
a first angular value of the first dimensional direction angle corresponding to the second receive beam in the terminal;
a number of second dimensional direction angles corresponding to the second receive beams in the terminal;
a second angular value of the second dimensional direction angle corresponding to the second receive beam in the terminal; or
a second beam identifier corresponding to the second receive beam in the terminal.

Other detailed introductions regarding the second receive beam characteristic can be found in the description of the above embodiments, and the embodiments of the present disclosure will not be repeated herein.

Further, in an embodiment of the present disclosure, the first receive beam characteristic is the number of receive beam(s) supported by the AI beam model, and the second receive beam characteristic is the number of receive beam(s) supported by the terminal. The first receive beam characteristic includes the number of a plurality of receive beams.

Alternatively, the number of receive beam(s) included in the first receive beam characteristic is less than or equal to the number of receive beam(s) included in the second receive beam characteristic.

In an embodiment of the present disclosure, “the number of receive beam(s) included in the first receive beam characteristic is less than or equal to the number of receive beam(s) included in the second receive beam characteristic” is used to indicate that the number of receive beam(s) supported by the AI model is less than or equal to the number of receive beam(s) supported by the terminal.

Exemplarily, the first receive beam characteristic is the number of receive beam(s) supported by the AI beam model, the second receive beam characteristic is the number of receive beam(s) supported by the terminal, and the number of receive beam(s) supported by the terminal, for instance, may range from 2 to 8.

In summary, in embodiments of the present disclosure, the network side device may send the AI beam model to the terminal. In the embodiments of the present disclosure, the network side device can determine the AI beam model based on the second receive beam characteristic by receiving the AI beam model request and/or the second receive beam characteristic sent by the terminal, which can improve the matching performance between the input parameter determined by the terminal and the AI model. The present disclosure provides a processing method for the case of “a method for determining an AI beam model” to provide the receive beam characteristic corresponding to the AI beam model, which improves the accuracy of obtaining a prediction result corresponding to a beam measurement quality of the AI beam model.

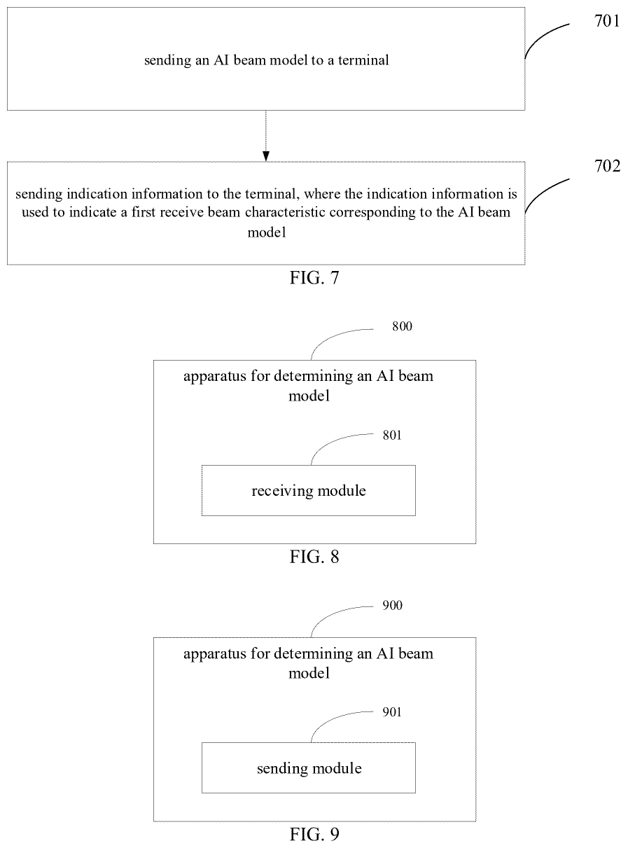

FIG. 7 is a flowchart of a method for determining an AI beam model provided by an embodiment of the present disclosure. This method is performed by a network side device, and as shown in FIG. 7, may include the following steps.

Step 701, sending an AI beam model to a terminal.

Step 702, sending indication information to the terminal, where the indication information is used to indicate a first receive beam characteristic corresponding to the AI beam model.

In an embodiment of the present disclosure, the first receive beam characteristic includes at least one of the following:
a first number of first receive beams supported by the AI beam model;
a number of first dimensional direction angles corresponding to the first receive beams in the AI beam model;
a first angular value of the first dimensional direction angle corresponding to the first receive beam in the AI beam model;
a number of second dimensional direction angles corresponding to the first receive beams in the AI beam model;
a second angular value of the second dimensional direction angle corresponding to the first receive beam in the AI beam model; or
a first beam identifier corresponding to the first receive beam in the AI beam model.

Other detailed introductions regarding the first receive beam characteristic can be found in the description of the above embodiments, and the embodiments of the present disclosure will not be repeated herein.

In an embodiment of the present disclosure, the order of execution of steps 701 and 702 is not limited. That is, the network side device may first perform step 701 (i.e., sending the AI beam model to the terminal), and then perform step 702 (i.e., sending the indication information to the terminal). Alternatively, the network side device may first perform step 702 (i.e., sending the indication information to the terminal), and then perform step 701 (i.e., sending the AI beam model to the terminal). Alternatively, the network side device may perform step 701 (i.e., sending the AI beam model to the terminal) and step 702 (i.e., sending the indication information to the terminal) simultaneously.

In summary, in embodiments of the present disclosure, the network side device may send the AI beam model to the terminal. In the embodiments of the present disclosure, the matching performance, between the input parameter determined by the terminal and the AI model, can be improved by the network side device sending the indication information and the AI beam model to the terminal. The present disclosure provides a processing method for the case of “a method for determining an AI beam model” to provide the receive beam characteristic corresponding to the AI beam model, which improves the accuracy of obtaining a prediction result corresponding to a beam measurement quality of the AI beam model.

FIG. 8 is a schematic diagram of a structure of an apparatus for determining an AI beam model provided by an embodiment of the present disclosure. As shown in FIG. 8, the apparatus 800 may include:
a receiving module 801 configured to receive an AI beam model sent by a network side device, and determine a first receive beam characteristic corresponding to the AI beam model.

In summary, in the apparatus for determining the AI beam model according to the embodiments of the present disclosure, the terminal may receive the AI beam model sent by the network side device, and determine the first receiving beam characteristic corresponding to the AI beam model. In the embodiments of the present disclosure, by determining the first receive beam characteristic corresponding to the AI beam model through the terminal, the situation where the AI beam model does not correspond to the first receive beam characteristic is reduced, thereby improving the beam prediction accuracy of the AI beam model. The present disclosure provides a processing method for the case of “a method for determining an AI beam model” to provide the receive beam characteristic corresponding to the AI beam model, which improves the accuracy of obtaining a prediction result corresponding to a beam measurement quality of the AI beam model.

In an embodiment of the present disclosure, the receiving module 801 is further configured to send an AI beam model request and/or a second receive beam characteristic to the network side device before receiving the AI beam model sent by the network side device.

In an embodiment of the present disclosure, the receiving module 801, when configured to determine the first receive beam characteristic corresponding to the AI beam model, is specifically configured to:
receive indication information sent by the network side device, where the indication information is configured to indicate the first receive beam characteristic corresponding to the AI beam model; or
determine the first receive beam characteristic corresponding to the AI beam model based on a default rule.

In an embodiment of the present disclosure, the first receive beam characteristic includes at least one of the following:
a first number of first receive beams supported by the AI beam model;
a number of first dimensional direction angles corresponding to the first receive beams in the AI beam model;
a first angular value of the first dimensional direction angle corresponding to the first receive beam in the AI beam model;
a number of second dimensional direction angles corresponding to the first receive beams in the AI beam model;
a second angular value of the second dimensional direction angle corresponding to the first receive beam in the AI beam model; or
a first beam identifier corresponding to the first receive beam in the AI beam model.

In an embodiment of the present disclosure, the second receive beam characteristic includes at least one of the following:
a second number of second receive beams supported by the terminal;
a number of first dimensional direction angles corresponding to the second receive beams in the terminal;
a first angular value of the first dimensional direction angle corresponding to the second receive beam in the terminal;
a number of second dimensional direction angles corresponding to the second receive beams in the terminal;
a second angular value of the second dimensional direction angle corresponding to the second receive beam in the terminal; or
a second beam identifier corresponding to the second receive beam in the terminal.

In an embodiment of the present disclosure, the receiving module 801 is further configured to determine an AI beam model input parameter and input the input parameter into the AI beam model to obtain a prediction result of a beam measurement quality after receiving the AI beam model sent by the network side device, where the input parameter includes at least one of:
a second receive beam characteristic;
beam pair IDs corresponding to a third number of beam pairs; or
a beam measurement quality corresponding to the third number of beam pairs.

In an embodiment of the present disclosure, the beam pair ID corresponds to a reference signal ID and a second receive beam identifier, where the reference signal includes at least one of at least one of: a synchronization signal block (SSB) or a channel state information reference signal (CSI-RS).

In an embodiment of the present disclosure, the beam measurement quality includes a layer one reference signal receiving power (L1-RSRP) and/or a layer one signal to interference plus noise ratio (L1-SINR).

In an embodiment of the present disclosure, the first receive beam characteristic is a number of receive beams supported by the AI beam model, a second receive beam characteristic is a number of receive beams supported by the terminal, and the first receive beam characteristic comprises a number of a plurality of receive beams;
or the number of receive beams included in the first receive beam characteristic is less than or equal to the number of receive beams included in the second receive beam characteristic.

FIG. 9 is a schematic diagram of a structure of an apparatus for determining an AI beam model provided by an embodiment of the present disclosure. As shown in FIG. 9, the apparatus 900 may include:
a sending module 901 configured to send an AI beam model to a terminal.

In summary, in the apparatus for determining the AI beam model according to embodiments of the present disclosure, the network side device may send the AI beam model to the terminal. In the embodiments of the present disclosure, the matching performance, between the input parameter determined by the terminal and the AI model, can be improved by the network side device indicating the first receive beam characteristic corresponding to the AI beam model. The present disclosure provides a processing method for the case of “a method for determining an AI beam model” to provide the receive beam characteristic corresponding to the AI beam model, which improves the accuracy of obtaining a prediction result corresponding to a beam measurement quality of the AI beam model.

In an embodiment of the present disclosure, an AI beam model request and/or a second receive beam characteristic sent by the terminal is received.

In an embodiment of the present disclosure, the second receive beam characteristic includes at least one of the following:
a second number of second receive beams supported by the terminal;
a number of first dimensional direction angles corresponding to the second receive beams in the terminal;
a first angular value of the first dimensional direction angle corresponding to the second receive beam in the terminal;
a number of second dimensional direction angles corresponding to the second receive beams in the terminal;
a second angular value of the second dimensional direction angle corresponding to the second receive beam in the terminal; or
a second beam identifier corresponding to the second receive beam in the terminal.

In an embodiment of the present disclosure, the sending module 901, when configured to send the AI beam model to the terminal, is specifically configured to:
send indication information to the terminal, where the indication information is configured to indicate a first receive beam characteristic corresponding to the AI beam model.

In an embodiment of the present disclosure, the first receive beam characteristic includes at least one of the following:
a first number of first receive beams supported by the AI beam model;
a number of first dimensional direction angles corresponding to the first receive beams in the AI beam model;
a first angular value of the first dimensional direction angle corresponding to the first receive beam in the AI beam model;
a number of second dimensional direction angles corresponding to the first receive beams in the AI beam model;
a second angular value of the second dimensional direction angle corresponding to the first receive beam in the AI beam model; or
a first beam identifier corresponding to the first receive beam in the AI beam model.

In an embodiment of the present disclosure, a first receive beam characteristic is a number of receive beams supported by the AI beam model, a second receive beam characteristic is a number of receive beams supported by the terminal, and the first receive beam characteristic includes a number of a plurality of receive beams, or the number of receive beams included in the first receive beam characteristic is less than or equal to the number of receive beams included in the second receive beam characteristic.

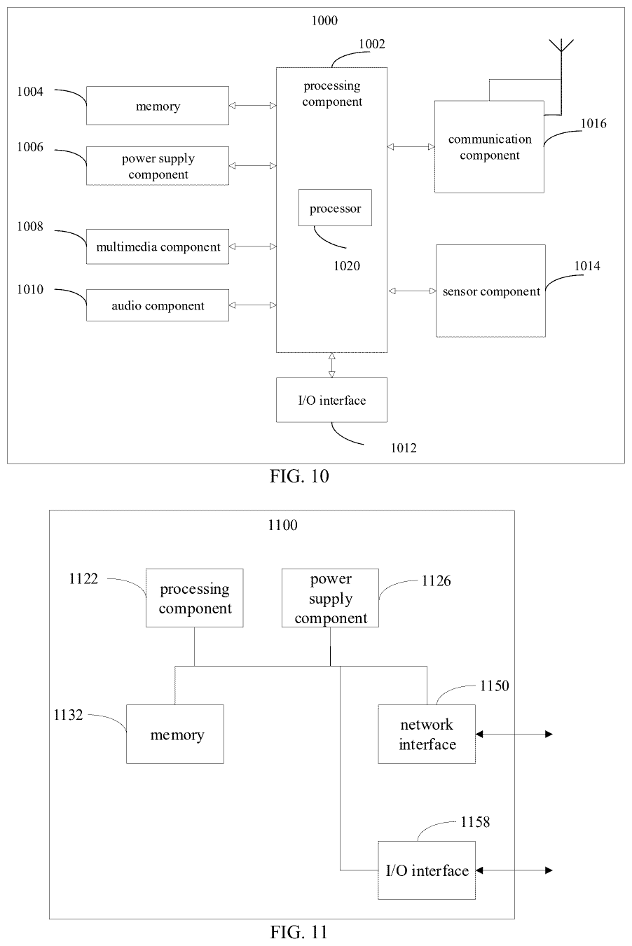

FIG. 10 is a block diagram of a terminal UE 1000 provided by an embodiment of the present disclosure. For example, the UE 1000 may be a cell phone, a computer, a digital broadcast terminal, a message transceiver device, a game console, a tablet device, a medical device, a fitness device, a personal digital assistant, and the like.

Referring to FIG. 10, the UE 1000 may include at least one of the following components: a processing component 1002, a memory 1004, a power supply component 1006, a multimedia component 1008, an audio component 1010, an input/output (I/O) interface 1012, a sensor component 1014, and a communication component 1016.

The processing component 1002 generally controls the overall operation of the UE 1000, such as operations associated with display, telephone calls, data communications, camera operations, and recording operations. The processing component 1002 may include at least one processor 1020 to execute instructions to accomplish all or some of the steps of the method described above. In addition, the processing component 1002 may include at least one module to facilitate interaction between the processing component 1002 and other components. For example, the processing component 1002 may include a multimedia module to facilitate interaction between the multimedia component 1008 and the processing component 1002.

The memory 1004 is configured to store various types of data to support operation at the UE 1000. Examples of such data include instructions for any application or method operating on the UE 1000, contact data, phone book data, messages, pictures, videos, etc. The memory 1004 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or CD-ROM.

The power supply component 1006 provides power to various components of the UE 1000. The power supply component 1006 may include a power management system, at least one power supply, and other components associated with generating, managing, and distributing power for the UE 1000.

The multimedia component 1008 includes a screen providing an output interface between the UE 1000 and a user. In some embodiments, the screen may include a liquid crystal display (LCD) and a touch panel (TP). If the screen includes a touch panel, the screen may be implemented as a touch screen to receive input signals from the user. The touch panel includes at least one touch sensor to sense touches, swipes and gestures on the touch panel. The touch sensor may not only sense the boundaries of the touch or swipe action, but also detect the wake-up time and pressure associated with the touch or swipe operation. In some embodiments, the multimedia component 1008 includes a front camera and/or a rear camera. The front camera and/or the rear camera may receive external multimedia data when the UE 1000 is in an operating mode, such as a shooting mode or a video mode. Each front camera and rear camera may be a fixed optical lens system or have a focal length and optical zoom capability.

The audio component 1010 is configured to output and/or input audio signals. For example, the audio component 1010 includes a microphone (MIC) that is configured to receive external audio signals when the UE 1000 is in an operational mode, such as a call mode, a recording mode, and a voice recognition mode. The received audio signals may be further stored in memory 1004 or sent via communication component 1016. In some embodiments, the audio component 1010 further includes a speaker for outputting the audio signal.

The I/O interface 1012 provides an interface between the processing component 1002 and a peripheral interface module. The peripheral interface module may be a keypad, a click wheel, a button, and the like. These buttons may include, but are not limited to: a home button, a volume button, a start button, and a lock button.

The sensor component 1014 includes at least one sensor for providing an assessment of various aspects of the state of the UE 1000. For example, the sensor component 1014 may detect an open/closed state of the device 1000, the relative positioning of components, such as the components being the display and keypad of the UE 1000, the sensor component 1014 may also detect a change in the position of the UE 1000 or one of the components of the UE 1000, the presence or absence of a user contact with the UE 1000, an orientation, acceleration or deceleration of the UE 1000, and a change in temperature of the UE 1000. The sensor component 1014 may include a proximity sensor configured to detect the presence of a nearby object in the absence of any physical contact. The sensor component 1014 may also include an optical sensor, such as a CMOS or CCD image sensor, for use in imaging applications. In some embodiments, the sensor component 1014 may also include an acceleration sensor, a gyroscope sensor, a magnetic sensor, a pressure sensor, or a temperature sensor.

The communication component 1016 is configured to facilitate communication between the UE 1000 and other devices by wired or wireless means. The UE 1000 may access a wireless network based on a communication standard, such as Wi-Fi, 2G or 3G, or a combination thereof. In an exemplary embodiment, the communication component 1016 receives broadcast signals or broadcast-related information from an external broadcast management system via a broadcast channel. In an exemplary embodiment, the communication component 1016 further includes a near field communication (NFC) module to facilitate short range communication. For example, the NFC module may be implemented based on Radio Frequency Identification (RFID) technology, Infrared Data Association (IrDA) technology, Ultra Wide Band (UWB) technology, Bluetooth® (BT) technology and other technologies.

In exemplary embodiments, the UE 1000 may be implemented by at least one application-specific integrated circuit (ASIC), digital signal processor (DSP), digital signal processing device (DSPD), programmable logic device (PLD), field-programmable gate array (FPGA), controller, microcontroller, microprocessor, or other electronic component for performing the method described above.

FIG. 11 is a block diagram of a network side device 1100 provided by embodiments of the present disclosure. For example, the network side device 1100 may serve as a network side device. Referring to FIG. 11, the network side device 1100 includes a processing component 1122, which further includes at least one processor, and a memory resource represented by a memory 1132 for storing instructions, such as an application program, that may be executed by the processing component 1122. The application program stored in memory 1132 may include one or more modules each corresponding to a set of instructions. In addition, the processing component 1122 is configured to execute instructions to perform any of the methods described in the foregoing method applied to the network side device, e.g., the method shown in FIG. 1.

The network side device 1100 may also include a power supply component 1126 configured to perform power management of the network side device 1100, a wired or wireless network interface 1150 configured to connect the network side device 1100 to a network, and an input/output (I/O) interface 1158. The network side device 1100 may operate an operating system based on the operating system stored in the memory 1132, such as Windows Server™, Mac OS XTM, Unix™, Linux™, Free BSD™ or the like.

In the above-described embodiments provided in the present disclosure, the methods provided in the embodiments of the present disclosure are described from the perspectives of the network side device, and the UE, respectively. In order to realize each of the functions in the method provided by the above embodiments of the present disclosure, the network side device and the UE may include a hardware structure, a software module, and realize each of the above functions in the form of a hardware structure, a software module, or a hardware structure plus a software module. A function of the above-described functions may be performed in the form of a hardware structure, a software module, or a hardware structure plus a software module.

A communication device is provided in an embodiment of the present disclosure. The communication device may include a transceiver module and a processing module. The transceiver module may include a sending module and/or a receiving module, the sending module for realizing a sending function, and the receiving module for realizing a receiving function, and the transceiver module may realize the sending function and/or the receiving function.

The communication device may be a terminal device (such as the terminal in the foregoing method embodiments), a device in the terminal device, or a device capable of being matched for use with the terminal device. Alternatively, the communication device may be a network device, or a device in a network device, or a device capable of being matched for use with a network device.

Another communication device is provided by an embodiment of the present disclosure. The communication device may be a network device, a terminal device (such as the terminal in the foregoing method embodiments), a chip, a chip system, or a processor, etc., that supports the network device to realize the above-described methods, or a chip, a chip system, or a processor, etc., that supports the terminal device to realize the above-described methods. The device may be used to realize the method described in the foregoing method embodiments, as can be seen in the description in the above method embodiments.

The communication device may include one or more processors. The processor may be a general purpose processor or a specialized processor, etc. For example, it may be a baseband processor or a central processor. The baseband processor may be used for processing communication protocols as well as communication data, and the central processor may be used for controlling the communication device (e.g., a network side device, a baseband chip, a terminal, a terminal chip, a DU or a CU, etc.), executing a computer program, and processing data from the computer program.

Optionally, the communication device may further include one or more memories on which a computer program may be stored, the processor executing the computer program to cause the communication device to perform the method described in the above method embodiments. Optionally, data may also be stored in the memory. The communication device and the memory may be provided separately or may be integrated together.

Optionally, the communication device may also include a transceiver, an antenna. The transceiver may be referred to as a transceiver unit, a transceiver device, or a transceiver circuit, etc., and is used to implement the transceiver function. The transceiver may include a receiver and a transmitter, the receiver may be referred to as a receiver device or a receiving circuit, etc., for realizing the receiving function, and the transmitter may be referred to as a transmitter device or a transmitting circuit, etc., for realizing the transmitting function.

Optionally, one or more interface circuits may also be included in the communication device. The interface circuit is used to receive code instructions and transmit them to a processor. The processor runs the code instructions to cause the communication device to perform the method described in the method embodiments above.

When the communication device is a terminal device (such as the terminal in the forgoing method embodiments), the processor is used to perform the method shown in any of FIGS. 1-4.

When the communication device is a network side device, the processor is used to perform the method shown in any of FIGS. 5-7.

In one embodiment, a transceiver for implementing receiving and transmitting functions may be included in the processor. The transceiver may be, for example, a transceiver circuit, or an interface, or an interface circuit. The transceiver circuit, interface, or interface circuit for implementing the receiving and transmitting functions may be separate or may be integrated together. The transceiver circuit, interface, or interface circuit described above may be used for code/data reading and writing, or, the transceiver circuit, interface, or interface circuit described above may be used for signal transmission or delivery.

In one embodiment, the processor may store a computer program, and the computer program running on the processor may cause the communication device to perform the methods described in the method embodiments above. The computer program may be solidified in the processor, in which case the processor may be implemented by hardware.

In one embodiment, the communication device may include a circuit that can realize the functions of sending, receiving, or communicating as described in the aforementioned method embodiments. The processor and transceiver described in this disclosure can be implemented on an integrated circuit (IC), analog IC, radio frequency integrated circuit (RFIC), mixed-signal IC, application specific integrated circuit (ASIC), printed circuit board (PCB), electronic device, etc. The processor and transceiver can also be manufactured using various IC process technologies, such as complementary metal oxide semiconductor (CMOS), n-type metal oxide semiconductor (NMOS), positive channel metal oxide semiconductor (PMOS), bipolar junction transistor (BJT), BiCMOS, silicon-germanium (SiGe), gallium arsenide (GaAs), etc.

The communication device in the above description of embodiments may be a network device or a terminal device (such as the terminal in the forgoing method embodiments), but the scope of the communication device described in this disclosure is not limited to this, and the structure of the communication device may not be limited. The communication device may be a stand-alone device or may be part of a larger device. For example, the described communication device may be:
(1) A stand-alone integrated circuit IC, or chip, or, system-on-a-chip or subsystem;
(2) Having a collection of one or more ICs, optionally, the collection of ICs may also include storage components for storing data, computer programs;
(3) ASICs, such as modems;
(4) Modules that can be embedded in other equipment;
(5) Receivers, terminal devices, intelligent terminal devices, cellular phones, wireless devices, handhelds, mobile units, in-vehicle devices, network devices, cloud devices, artificial intelligence devices, and so on;
(6) Others, etc.

For the case where the communication device may be a chip or a system-on-a-chip, the chip includes a processor and an interface. There may be one or more processors and one or more interfaces.

Optionally, the chip further includes a memory, the memory being used to store necessary computer programs and data.

Those skilled in the art may also appreciate that the various illustrative logical blocks and steps set forth in embodiments of the present disclosure may be implemented by electronic hardware, computer software, or a combination of both. Whether such functionality is implemented by hardware or software depends on the particular application and the design requirements of the overall system. Those skilled in the art may, for each particular application, use various methods to implement the described functionality, but such implementations should not be construed as being beyond the scope of protection of the embodiments of the present disclosure.

The present disclosure also provides a readable storage medium having stored thereon instructions which, when executed by a computer, realize the functions of any of the method embodiments described above.

The present disclosure also provides a computer program product that, when executed by a computer, implements the functions of any of the method embodiments described above.

In the above embodiments, this may be implemented in whole or in part by software, hardware, firmware, or any combination thereof. When implemented using software, it may be implemented, in whole or in part, in the form of a computer program product. The computer program product includes one or more computer programs. Loading and executing the computer program on a computer produces, in whole or in part, a process or function in accordance with embodiments of the present disclosure. The computer may be a general purpose computer, a specialized computer, a computer network, or other programmable device. The computer program may be stored in a computer-readable storage medium or transmitted from one computer-readable storage medium to another computer-readable storage medium, e.g., the computer program may be transmitted from a web site, computer, server, or data center via a wired (e.g., coaxial cable, fiber optic, digital subscriber line (DSL)) or wireless (e.g., infrared, wireless, microwave, etc.) to another website site, computer, server, or data center. The computer-readable storage medium may be any usable medium to which a computer has access or a data storage device such as a server, data center, etc. containing one or more usable media integrated. The usable medium may be a magnetic medium (e.g., floppy disk, hard disk, tape), an optical medium (e.g., a high-density digital video disc (DVD)), or a semiconductor medium (e.g., a solid state disk (SSD)), among others.

A person of ordinary skill in the art may understand that the “first,” “second,” and other various numerical numbers involved in the present disclosure are only described for the convenience of differentiation, and are not used to limit the scope of the embodiments of the present disclosure, or to indicate the order of precedence.

The “at least one” of the present disclosure may also be described as “one or more”. The “plurality” may refer to two, three, four, or more, without limitation of the present disclosure. In embodiments of the present disclosure, for one type of technical features, the terms “first”, “second”, “third”, “A”, “B”, “C”, and “D”, etc., are used to distinguish the technical features of this type. The terms “first”, “second”, “third”, “A”, “B”, “C” and “D” describe the technical features in no order of priority or size.

After considering the specification and practicing the disclosure disclosed here, those skilled in the art will easily conceive of other embodiments of the present disclosure. This disclosure is intended to cover any variations, uses, or adaptive modifications of the disclosure, which follow the general principles of the disclosure and include commonly known knowledge or customary technical means in the technical field that are not explicitly disclosed in this disclosure. The specification and embodiments should only be regarded as exemplary. The true scope and spirit of the present disclosure are indicated by the following claims.

It should be understood that this disclosure is not limited to the exact structures that have been described above and illustrated in the accompanying drawings, and various modifications and changes may be made without departing from its scope. The scope of the disclosure is limited only by the appended claims.

1. A method for determining an Artificial Intelligence (AI) beam model, performed by a terminal, the method comprising:
receiving an AI beam model sent by a network side device, and
determining a first receive beam characteristic corresponding to the AI beam model.

2. The method according to claim 1, further comprising at least one of:
sending an AI beam model request to the network side device; or
sending a second receive beam characteristic to the network side device.

3. The method according to claim 1, wherein determining the first receive beam characteristic corresponding to the AI beam model comprises:
receiving indication information sent by the network side device, wherein the indication information is configured to indicate the first receive beam characteristic corresponding to the AI beam model; or
determining the first receive beam characteristic corresponding to the AI beam model based on a default rule.

4. The method according to claim 1, wherein the first receive beam characteristic comprises at least one of:
a first number of first receive beams supported by the AI beam model;
a number of first dimensional direction angles corresponding to the first receive beams in the AI beam model;
a first angular value of the first dimensional direction angle corresponding to the first receive beam in the AI beam model;
a number of second dimensional direction angles corresponding to the first receive beams in the AI beam model;
a second angular value of the second dimensional direction angle corresponding to the first receive beam in the AI beam model; or
a first beam identifier corresponding to the first receive beam in the AI beam model.

5. The method according to claim 2, wherein the second receive beam characteristic comprises at least one of:
a second number of second receive beams supported by the terminal;
a number of first dimensional direction angles corresponding to the second receive beams in the terminal;
a first angular value of the first dimensional direction angle corresponding to the second receive beam in the terminal;
a number of second dimensional direction angles corresponding to the second receive beams in the terminal;
a second angular value of the second dimensional direction angle corresponding to the second receive beam in the terminal; or
a second beam identifier corresponding to the second receive beam in the terminal.

6. The method according to claim 1, further comprising:
determining an AI beam model input parameter and inputting the input parameter into the AI beam model to obtain a prediction result of a beam measurement quality, wherein the input parameter comprises at least one of:
a second receive beam characteristic;
a beam pair characteristic corresponding to a third number of beam pairs; or
a beam measurement quality corresponding to the third number of beam pairs.

7. The method according to claim 6, wherein the beam pair characteristic comprises at least one of:
a beam pair identity (ID) corresponding to the beam pair;
a reference signal ID corresponding to the beam pair, wherein a reference signal comprises at least one of: a synchronization signal block (SSB) or a channel state information reference signal (CSI-RS);
a second beam identifier corresponding to a second receive beam, the second receive beam corresponding to the beam pair;
a first angular value of a first dimensional direction angle of the second receive beam corresponding to the beam pair; or
a second angular value of a second dimensional direction angle of the second receive beam corresponding to the beam pair.

8. The method according to claim 6, wherein the beam measurement quality comprises at least one of: a layer one reference signal receiving power (L1-RSRP) or a layer one signal to interference plus noise ratio (L1-SINR).

9. The method according to claim 1, wherein the first receive beam characteristic is a number of at least one receive beam supported by the AI beam model, a second receive beam characteristic is a number of at least one receive beam supported by the terminal, and the first receive beam characteristic comprises a number of a plurality of receive beams;
or wherein the number of at least one receive beam included in the first receive beam characteristic is less than or equal to the number of at least one receive beam included in the second receive beam characteristic.

10. A method for determining an Artificial Intelligence (AI) beam model, performed by a network side device, the method comprising:
sending an AI beam model to a terminal.

11. The method according to claim 10, wherein, further comprising at least one of:
receiving an AI beam model request sent by the terminal; or
receiving a second receive beam characteristic sent by the terminal.

12. The method according to claim 11, wherein the second receive beam characteristic comprises at least one of:
a second number of second receive beams supported by the terminal;
a number of first dimensional direction angles corresponding to the second receive beams in the terminal;
a first angular value of the first dimensional direction angle corresponding to the second receive beam in the terminal;
a number of second dimensional direction angles corresponding to the second receive beams in the terminal;
a second angular value of the second dimensional direction angle corresponding to the second receive beam in the terminal; or
a second beam identifier corresponding to the second receive beam in the terminal.

13. The method according to claim 11, further comprising:
sending indication information to the terminal, wherein the indication information is configured to indicate a first receive beam characteristic corresponding to the AI beam model.

14. The method according to claim 13, wherein the first receive beam characteristic comprises at least one of:
a first number of first receive beams supported by the AI beam model;
a number of first dimensional direction angles corresponding to the first receive beams in the AI beam model;
a first angular value of the first dimensional direction angle corresponding to the first receive beam in the AI beam model;
a number of second dimensional direction angles corresponding to the first receive beams in the AI beam model;
a second angular value of the second dimensional direction angle corresponding to the first receive beam in the AI beam model; or
a first beam identifier corresponding to the first receive beam in the AI beam model.

15. The method according to claim 10, wherein a first receive beam characteristic is a number of at least one receive beam supported by the AI beam model, and a second receive beam characteristic is a number of at least one receive beam supported by the terminal; and
wherein the first receive beam characteristic comprises a number of a plurality of receive beams, or
the number of at least one receive beam included in the first receive beam characteristic is less than or equal to the number of at least one receive beam included in the second receive beam characteristic.

16-17. (canceled)

18. A communication device, comprising:
a processor; and
a memory for storing a computer program executable by the processor;
wherein the processor is configured to perform following acts:
receiving an AI beam model sent by a network side device, and
determining a first receive beam characteristic corresponding to the AI beam model.

19. A communication device, comprising:
a processor; and
a memory for storing a computer program executable by the processor;
wherein the processor is configured to perform the method according to claim 10.

20-21. (canceled)

22. A non-transitory computer-readable storage medium, configured to store instructions which, when the instructions are executed by a processor, cause the processor to perform the method according to claim 1.

23. A non-transitory computer-readable storage medium, configured to store instructions which, when the instructions are executed by a processor, cause the processor to perform the method according to claim 10.

24. The communication device according to claim 18, wherein the processor is further configured to perform at least one of following acts:
sending an AI beam model request to the network side device; or
sending a second receive beam characteristic to the network side device.
